(19) United States
(12) Patent Application Publication
(10) Pub. No.: US 2026/0196837 A1
(43) Pub. Date: Jul. 9, 2026

(54) Hydrogen Energy Storage and Energy Aggregation Systems Utilizing Machine Learning

(71) Applicant: Orega Technologies, Tempe, AZ (US)

(72) Inventors: Herve-David Gregoire-Mazzocco, Las Vegas, NV (US); Sean G. Widmer, Mesa, AZ (US)

(21) Appl. No.: 19/402,763

(22) Filed: Nov. 26, 2025

Related U.S. Application Data
(63) Continuation-in-part of application No. 17/901,446, filed on Sep. 1, 2022.
(60) Provisional application No. 63/240,141, filed on Sep. 2, 2021.
(60) Provisional application No. 63/240,296, filed on Sep. 2, 2021.

(51) Int. Cl. H02J 3/32; C25B 1/04; H02J 3/00; H02J 3/14; H02J 3/175; H02J 3/38; H02J 7/35; H02J 7/44; H02J 7/45; H02J 7/82; H02J 15/50; H02J 101/24; H02J 101/30; H02J 103/35; H02J 103/40; H02J 105/12; H02J 105/42; H02J 105/50; H02J 105/52

(52) U.S. Cl. CPC H02J 3/32; C25B 1/04; H02J 3/14; H02J 3/175; H02J 3/381; H02J 7/35; H02J 7/45; H02J 7/82; H02J 15/50; H02J 3/003; H02J 7/44; H02J 2101/24; H02J 2101/30; H02J 2103/35; H02J 2103/40; H02J 2105/12; H02J 2105/42; H02J 2105/51; H02J 2105/52; H02J 2207/20

(57) ABSTRACT

An energy control system employing agentic machine learning techniques to intelligently manage hydrogen production and storage, solar energy production, and interfacing with external systems such as the grid and virtual power plants (VPPs). In accordance with various embodiments of the present invention, a hydrogen storage assembly includes an electrolyzer, a hydrogen storage system, a hydrogen fuel cell, an inverter, an electrochemical energy storage module (e.g., batteries), a power conversion system, and a control system incorporating machine learning techniques, such as reinforcement learning models used to train a set of specialized agents configured to intelligently handle surplus and deficit power conditions during on-grid and off-grid states. The systems and methods may be used, for example, to optimize energy distribution based on behavioral metadata and to implement a fractal grid architecture.

### CROSS-REFERENCE TO RELATED APPLICATIONS

The present application is a continuation-in-part of U.S. patent application Ser. No. 17/901,446, Entitled Systems and Methods for Hydrogen Energy and Energy AGGREGATION, filed Sep. 1, 2022, which claims priority to U.S. Provisional Patent Application Ser. No. 63/240,141, entitled SYSTEMS AND METHODS FOR ENERGY AGGREGATION, filed Sep. 2, 2021, and claims priority to U.S. Provisional Patent Application Ser. No. 63/240,296, entitled SYSTEMS AND METHODS FOR HYDROGEN ENERGY STORAGE, filed Sep. 2, 2,021 the entire contents of which are hereby incorporated by reference.

### TECHNICAL FIELD

The present invention relates, generally, to energy storage and aggregation systems and, more particularly, to intelligent hydrogen storage systems incorporating machine learning techniques.

### BACKGROUND

Recent years have seen a dramatic increase in the use of renewable energy sources. The U.S. Energy Information Administration (EIA), for example, projects that renewable energy's share of U.S. electricity generation will rise to about 26% by 2026, and that solar energy is expected to account for more than half of all new utility-scale electrical capacity additions in 2025.

Despite the increased use of solar energy, the methods of storing and using that energy in an efficient manner remain unsatisfactory in a number of respects. Furthermore, the increase in intermittent renewable energy systems connected to the power grid, such as solar photovoltaic energy, is having a dramatic effect on the overall behavior of the grid itself. One way to mitigate adverse effects, without engaging large grid investments, is to intelligently aggregate and manage distributed production and storage assets.

While some cloud-based aggregation engines have been developed to allow renewable energy companies to participate in utility markets, such systems are also unsatisfactory. For example, known energy aggregation systems often rely on standard, unsecure public networks, thereby increasing cybersecurity and other risks. Furthermore, such systems are generally fragmented (rather than integrated) and are not capable of intelligently optimizing the behavior of assets to achieve optimum use and marketization. This is particularly the case with regard to utility ancillary services bidding platforms, which are experiencing increased popularity in recent years.

Accordingly, systems and methods are therefore needed to overcome these and other limitations of prior art electrical energy aggregation and storage systems.

### SUMMARY OF THE INVENTION

The present subject matter relates to an energy control system employing agentic

machine learning techniques to intelligently manage hydrogen production and storage, solar energy production, and interfacing with a smart breaker system associated with the the consumer premises as well as external systems such as the grid and virtual power plants (VPPs). In accordance with various embodiments of the present invention, a hydrogen storage assembly includes an electrolyzer, a hydrogen storage system, a hydrogen fuel cell, an electrochemical energy storage module (e.g., batteries), an inverter, a power conversion system, and a control system incorporating machine learning techniques, such as reinforcement learning models used to train a set of specialized agents configured to intelligently handle surplus and deficit power conditions during on-grid and off-grid states. In this way, the system achieves optimal financial and energy-use objectives. In accordance with additional embodiments, systems and methods are disclosed for using behavioral metadata and managing fractal grid architectures.

### BRIEF DESCRIPTION OF THE DRAWING FIGURES

The present invention will hereinafter be described in conjunction with the appended drawing figures, wherein like numerals denote like elements, and:

FIG. 1 is a conceptual overview of an energy generation and storage system in accordance with one embodiment;

FIG. 2 is a block diagram illustrating the energy generation and storage system of FIG. 1 implementing various machine learning components; and

FIG. 3 is a combination block diagram and flowchart showing a method in accordance with one embodiment.

### DETAILED DESCRIPTION OF PREFERRED EXEMPLARY EMBODIMENTS

The present subject matter relates to machine learning systems and methods for hydrogen-based storage and aggregation. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to machine learning models, solar energy, power distribution in a commercial or residential context, and hydrogen cells may not be described in detail herein.

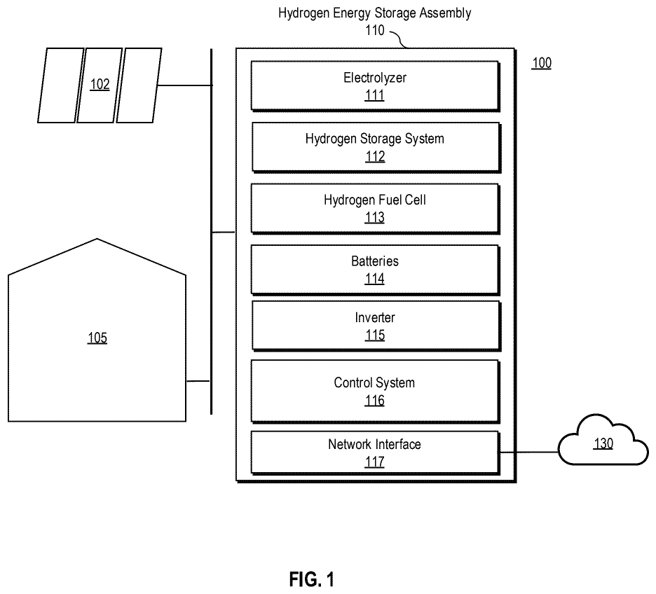

Referring now to the figures, FIG. 1 is a conceptual overview of an energy generation and storage system 100 in accordance with one embodiment, and which may be used in connection with a control system implementing machine learning as described in further detail below. In general, system 100 includes a hydrogen energy storage assembly (or simply “storage assembly”) 110, which is communicatively coupled to one or more power sources 102 (e.g., photovoltaic solar panel components), the electrical system of a residential or commercial site 105 (which generally consumes, in part, power from solar power system 102 and a connected power grid), and a network 130 (e.g., a proprietary network or VPN) communicatively coupled to network interface 117.

Hydrogen storage assembly 110 generally includes an electrolyzer 111, a hydrogen storage system 112, a hydrogen fuel cell 113, a battery energy storage system 114, an inverter 115, a control system 116, and the network communication interface (or simply “interface”) 117, which provides data communication via network 130. It will be appreciated that, in the interest of simplicity, a number of commonly known components have not been included in FIG. 1, such as power conversion systems, inverters, fuse boxes, meters, switches, wiring, power conditioning units, and the like, many of which will be described in further detail below.

In generally, electrolyzer 111 is configured to accept a water source (not shown) and electrical power to separate—via electrolysis—the water into hydrogen gas (which is suitably stored via hydrogen storage system 112), and oxygen gas, which is vented or otherwise ejected for the system for further processing.

Hydrogen storage system 112 may use a variety of techniques to store hydrogen produced by electrolyzer 111. In one embodiment, a metal hydride or other such storage device is used, thereby allowing the gas to be stored within a metal powder, which has significant safety advantages over high-pressure tank systems. Depending upon the embodiment, the system 220 may store hydrogen in the range of 2 kg (producing approximately 30 kWh) to 10 kg (producing approximately 150 kWh), although the invention is not so limited. In general, 1 kg of H2 contains an intrinsic energy of about 33.3 kWh at LHV (Low Heating Value). When using a fuel cell (e.g., FC 113), and considering efficiency and system parasitic loads, the resulting usable energy is approximately 15 kWh/kg H2.

Hydrogen fuel cell 113 is configured to convert hydrogen gas into electricity and water, as is known in the art. The resulting electrical energy is transferred to an electrical power conversion system, which converts DC to DC and DC to AC, thereby providing a simple plug-and-play interface that is easy to install in a residential or commercial environment.

Batteries 114 form an electrochemical energy storage system that serves as an energy buffer that allows the system to respond quickly to transient energy needs. Batteries 114 may be implemented using a variety of technologies, such as ultra-capacitors, LiPo or NiMH battery arrays, and the like.

Inverter 115 functions as a bridge between the photovoltaic panels (102) and the electrical grid by converting the generated DC to AC electricity used by household appliances, as is known in the art.

Control system 116 is suitably coupled to the other components of assembly 110 (via one or more data communication buses, interconnects, or other commonly known electrical systems and shown below) and is configured to control the storage and distribution of the stored hydrogen and electrical energy in an optimized manner (using various machine learning models) to achieve predefined financial and energy use objectives. For example, excess energy from solar panels 102 may be used to power electrolyzer 111 when control system 116 identifies an opportune time. When there is a significant demand for electrical power, control system 116 may feed hydrogen from storage system 112 to fuel cell 113 to produce energy for consumption by site 105.

Control system 116 may employ one or more machine learning or predictive analytics models to optimize energy usage, distribution, and/or storage. In this regard, the phrase “machine learning” model is used without loss of generality to refer to any result of an analysis that is designed to make some form of prediction, such as predicting the state of a response variable, clustering patients, determining association rules, and performing anomaly detection. Thus, for example, the term “machine learning” refers to models that undergo supervised, unsupervised, semi-supervised, and/or reinforcement learning. Such models may perform classification (e.g., binary or multiclass classification), regression, clustering, dimensionality reduction, and/or such tasks. Examples of such models include, without limitation, artificial neural networks (ANN) (such as a recurrent neural networks (RNN) and convolutional neural network (CNN)), reinforcement learning (RL) models such as proximal policy optimization (PPO) models, decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models.

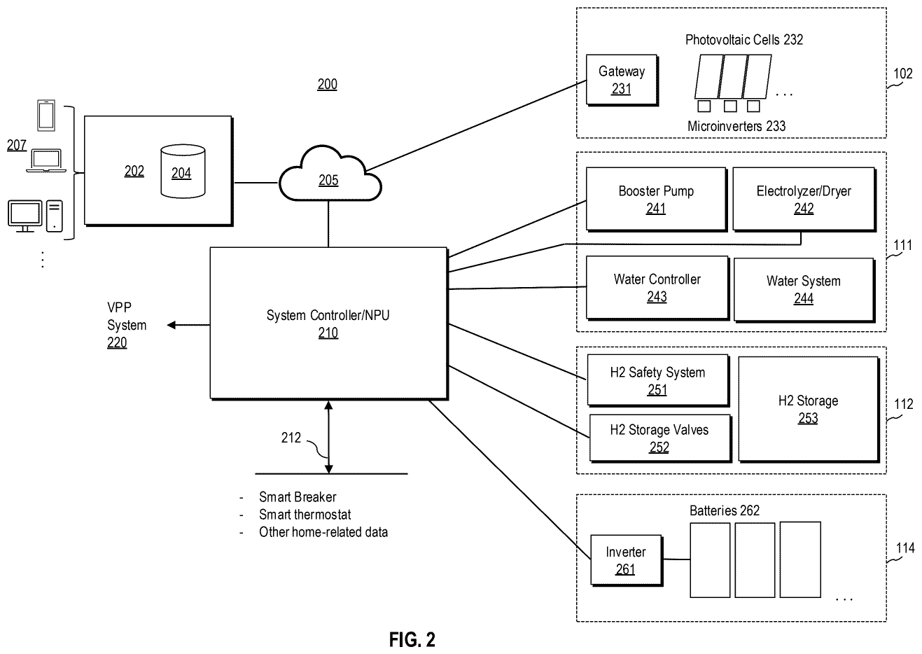

Referring now to the more detailed block diagram of FIG. 2, a control system 200 useful in implementing the system 100 of FIG. 1 will now be described in further detail. As shown, system 200 includes a system controller 210 (which may include any number of processors, neural processing units (NPUs), or other suitable hardware, and may function as control system 116 in FIG. 1), a server 202 with one more database components 204, various computing devices 207, a network 205, as well as various components illustrated in FIG. 1, e.g., solar panel system 102, hydrogen storage system 112, electrolyzer 111, and batteries 114.

System controller 210 operates as the supervisory intelligence of the entire architecture, coordinating electrical, water, and hydrogen subsystems as illustrated. It receives continuous data streams from sensors, smart home devices, safety modules, and energy-generation components (e.g., smart breaker data, smart thermostat data, and other home-related data indicated with reference numeral 212). Using this information, it determines when to allocate solar power to batteries, when to run the electrolyzer, how to manage water flow, and how to maintain safe hydrogen pressures and storage levels. It also serves as the interface between the home system and external platforms, issuing control commands, performing diagnostics, and optimizing the system's operation based on energy prices, weather, consumption patterns, and grid-service requirements. Controller 210 also communicates with a virtual power plant (VPP) system 220 as is known in the art.

Solar power system 102 generally includes photovoltaic cells 232 and associated microinverters 233, as well as a gateway 231 for interfacing with other components of system 200. The photovoltaic cells 232 convert sunlight into DC electricity, and the microinverters 233 condition and convert that energy into grid-synchronous AC power. This modular inverter topology improves efficiency, reduces shading losses, and allows granular control of each cell 232. The system controller, among other things, monitors solar output from solar power system 102 to determine how energy should be distributed among household loads, storage devices, or hydrogen production.

The inverter 261 and batteries 114 provide electrical storage and load balancing. The inverter 261 converts DC battery energy into AC household-compatible power and can also perform the reverse conversion to charge the batteries when excess electricity is available. The batteries absorb surplus solar generation (from solar energy system 102), provides backup power during outages, and supports strategies to reduce demand spikes. The system controller 210 regulates charging and discharging cycles to extend battery life, meet predicted household usage, and coordinate with hydrogen production schedules.

The water controller 243 and water system 244 supply the electrolyzer 111 with the appropriate water volume and quality. The water controller 243 manages flow rates, monitors purity, and ensures that the electrolyzer receives water within its operating parameters. Because hydrogen production depends heavily on controlled water input, this subsystem is tightly regulated by the system controller 210, which starts or pauses water delivery based on operational constraints.

The electrolyzer/dryer 242 is responsible for converting electrical power into hydrogen. During operation, the electrolyzer splits water into hydrogen and oxygen, consuming electrical energy sourced from solar panels, batteries, and/or the grid. The hydrogen stream then passes through a drying process to ensure that moisture content meets storage specifications. The H2 storage valves 252 and booster pump 241 regulate the movement and pressurization of hydrogen within the storage subsystem 112. Once the electrolyzer generates dry hydrogen, the valves meter its flow into storage vessels, while the booster pump increases pressure when required for efficient storage packing or for delivery to downstream applications. Flow routing, pressure thresholds, and valve positions are dictated by the system controller 210, ensuring effective and safe hydrogen handling.

The H2 safety system 251 provides real-time monitoring and protective functions across the hydrogen subsystem 112. In abnormal conditions, such as over-pressure, unusual flow patterns, or detected gas concentrations, the safety system 251 can override normal operation, vent pressure if necessary, or shut down the electrolyzer 242. Its continuous feedback loop with the system controller 210 allows the entire hydrogen subsystem to operate with fail-safe mechanisms always engaged.

H2 storage 253 is the repository for generated hydrogen, maintained under controlled pressure and environmental conditions. This storage unit allows the system to retain energy in molecular form for later use, enabling long-duration storage that complements the shorter-duration capacity of batteries 262.

System controller 210 receives a vast quantity of information, e.g., from a smart breaker, a smart thermostat, and other home-data interfaces provide the system with awareness of household consumption patterns. By integrating with these devices, the controller learns (using various machine learning techniques) when major loads activate, how heating and cooling cycles behave, and what energy-usage trends emerge over time. This information allows the controller to forecast demand, shift energy usage intelligently, and determine when to reserve or release energy from batteries or hydrogen storage. Users and other stakeholders are able to interface with system 200 via various user interfaces implemented via software running on computing devices 207 (e.g., desktop computers, laptops, tablets, smartphones, and the like).

The availability of smart breaker data allows tailoring energy use and storage based on behavioral metadata, i.e., how energy is used over time, on a very granular level, by individuals within the site. That is, the system may adjust usage, distribution, and storage of energy based on how individual appliances and other energy loads within the site are used.

The VPP system 220 links system 200 to the larger grid. Through this communication channel, the home can participate in grid-service markets, respond to demand-response signals, export stored energy, or curtail loads when requested. As is known in the art, a VPP is a decentralized energy management system that aggregates disparate Distributed Energy Resources (DERs) into a single, dispatchable operating profile. Utilizing cloud-based aggregation software, the VPP monitors and controls these assets via bidirectional communication protocols to simulate the generation and load characteristics of a traditional centralized power plant. This architecture enables the coordinated resources to deliver essential grid services, such as frequency regulation, voltage control, and peak demand response, by dynamically injecting power or modulating consumption in response to grid operator signals.

The system controller modulates solar, battery, and hydrogen-production operations to support grid stability while optimizing owner benefits. System controller may also be communicatively coupled to a network operations center (not shown), which itself is coupled to a utility ancillary services bidding platform (or simply “utility bidding platform”) associated with residential and/or commercial housing in a particular subdivision or other geographical area.

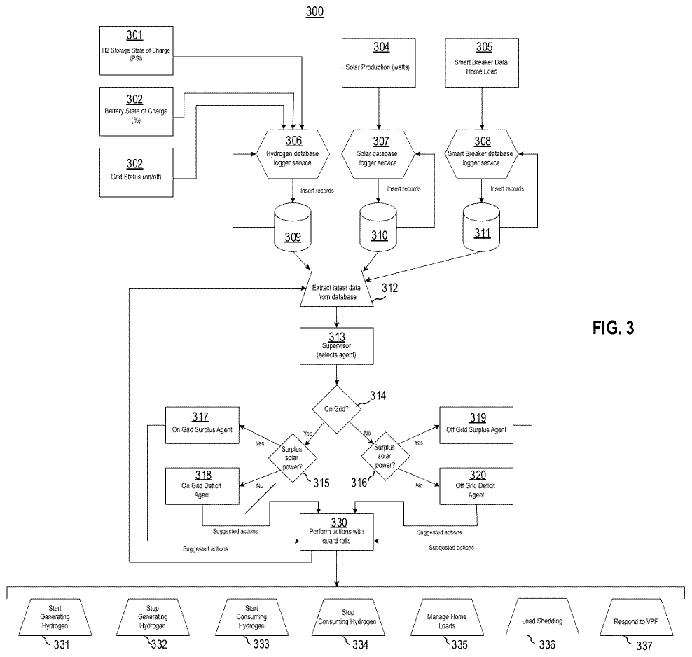

FIG. 3 is a combination block diagram/flowchart illustrating operation of system controller 210 in accordance with one embodiment. More particularly, a hydrogen database logger service 306 receives a data stream from various components of system 200, such as H2 storage state of charge 301 (e.g., a psi value), battery state of charge 302 (e.g., percent charge level), grid status 302 (e.g., Boolean true/false), and home load 304 (e.g., watts). The data is periodically (e.g., every five seconds) stored within a database 309.

Similarly, a solar database logger service 307 receives a data stream including, for example, solar production values 304 (e.g., watts) and periodically stores that data in a second database 310. The loop back from 310 to 307 indicates the periodic data sampling, which may be performed at any suitable rate.

A smart breaker database logger service 308 receives a data stream including, for example, smart breaker data/home load data 305 and periodically stores that data in a third database 311. The loop back from 311 to 308 indicates the periodic data sampling, which may be performed at any suitable rate.

At step 312, the latest data is extracted from databases 309, 310, and 311. A software-implemented agent then uses (at 313) that data to select an agent to use for further operation. That is, the supervisor is the heart of the system and, at some predetermined interval (e.g., every 15 minutes), gathers all necessary data from the various hardware systems as well as cloud-based forecasts. At step 314, it is determined whether system 200 is on-grid (e.g., via grid status data 302). If so, processing continues to step 315; if not, processing continues to step 316.

Next, regardless of whether path 315 or 316 is taken, the supervisor's task is to determine the current state of the system by calculating the net power (solar-load) and, based on this value, choosing which specialist agent to activate. Specifically, if the net power is greater than zero, there is a surplus, and an appropriate surplus agent is activated (agent 317 in the on-grid state, and agent 319 in the off-grid state). Conversely, if the net power is less than or equal to zero, there is a deficit, and an appropriate deficit agent is activated (agent 318 in the on-grid state, and agent 320 in the off-grid state). Depending upon which agent is activated, that agent then provides a “suggested action” (which may include, for example, a list of programmatic commands for every controllable device within system 200) and that action is then performed (at 330) with appropriate guard rails (e.g., clamped min and max values). Depending upon context, and which agent (317, 318, 319, 320) is activated, a range of actions may be implemented, including without limitation: “start generating hydrogen” (331), “stop generating hydrogen” (332), “start consuming hydrogen” (333), “stop consuming hydrogen” (334), manage home loads (335), load shedding (336), and respond to VPP (337).

In accordance with one embodiment, each of the agents are neural network models (e.g., PPO models) that have been trained on a corpus of past energy data to output an optimal output (i.e., suggested action). That is, each agent has been trained on the same observations but have implemented different reward functions. For example, surplus agents 317 and 319 are trained to maximize value from excess energy and have learned complex strategies such as pre-cooling the house, producing hydrogen, and selling power back to the grid. Similarly, deficit agents 318 and 320 are trained to minimize cost and ensure the integrity of the system. It has learned how to use stored energy efficiently and when to shed non-essential loads.

As mentioned above, a final layer of safety checks are applied (i.e., “guard rails”) when performing the action at step 330. These guard rails may include, for example, clamping values to minimum and maximum physical limits, which are known a priori based on the hardware used in the system and other factors.

In accordance with another embodiment, the general flow shown in FIG. 3 is employed in a “fractal” grid architecture. That is, while FIG. 3 illustrates use of certain ML techniques on a small scale (e.g., a single residence), those same techniques and architectures may be used at increasingly larger scales at the same time (e.g., a neighborhood, a town, a state, and so on). Stated another way, the grid is composed of self-similar, autonomous modular units (or microgrids) that repeat their structural and functional patterns across multiple scales. Borrowing from the mathematical concept of fractals, where a shape retains its complexity and pattern regardless of magnification, a fractal grid treats a single home, a neighborhood, a regional substation, and the entire utility operator as functionally equivalent “nodes.” Each node is capable of generation, storage, and load management, allowing it to operate in isolation (island mode) or federated with parent and child nodes to exchange power and data. The nodes are then operated in accordance with the logic set forth in FIG. 3, regardless of scale.

It will be appreciated that the multi-agent, hierarchical structure described above is powerful in that it allows training of highly specialized agents that are experts in one task (e.g., managing surplus or deficit energy conditions based on off-grid/on-grid state), while the supervisor acts as an intelligent conductor, choosing the correct agent based on current conditions.

The various machine learning models, user interfaces, and software systems described above may be implemented using a variety of proprietary and/or open source libraries known in the art, and may be deployed using any suitable programming language and software stack.

The illustrated systems and methods provide numerous advantages, such as control of the entire vertical business from home energy monitoring, flexible hydrogen-based storage, and a cloud based analytics system that can participate in virtual power plants and external markets.

In summary, what has been described is an energy control system including: a hydrogen energy storage assembly comprising an electrolyzer configured to separate, via electrolysis, water into hydrogen gas; a hydrogen storage system for storing the hydrogen gas produced by the electrolyzer; a hydrogen fuel cell configured to convert the stored hydrogen gas into electrical energy and water; an electrochemical energy storage module configured to function as an energy buffer; an inverter configured to convert the produced electrical energy to a desired form; a network interface; and a system controller communicatively coupled to a server system and a virtual power plant (VPP) service. A solar power system is communicatively coupled to the system controller and a consumer premises. The system controller is configured to: receive data including: (a) a state of charge of the hydrogen storage system; (b) a state of charge of the electrochemical energy storage module; (c) a grid status; (d) a solar production value from the solar power system; and (e) home load data; determine whether the consumer premises is on-grid based on the grid status; determine whether there is surplus solar power based on the home load data and the solar production value; activate a selected one of a set of specialized machine learning agents based on whether the customer premises is on-grid and whether there is surplus solar power; perform, within a set of guard rails, a suggested action provided by the selected specialized machine learning agent, wherein the suggested action is selected from the group consisting of: start generating hydrogen; stop generating hydrogen; start consuming hydrogen; stop consuming hydrogen; manage consumer premises loads; shed loads; and respond to the VPP service. The set of guard rails may include minimum and maximum values for the hydrogen energy storage assembly and the consumer premises loads. The specialized machine learning agents, in one embodiment, include an on-grid surplus agent, an on-grid deficit agent, an off-grid surplus agent, and an off-grid deficit agent. The data may be stored in a plurality of databases by respective logger services at a set of predetermined intervals. Each of the specialized machine learning agents may be implemented using a proximal policy optimization (PPO) model trained on past behavior of the energy control system. The consumer premises preferably includes a smart breaker system, and the home load data includes data from the smart breaker system.

Various systems and methods are described above in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, field-programmable gate arrays (FPGAs), Application Specific Integrated Circuits (ASICs), logic elements, look-up tables, network interfaces, or the like, which may carry out a variety of functions under the control of one or more microprocessors or other control devices either locally or in a distributed manner.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, individually or in any combination, including without limitation: application specific integrated circuits (ASICs), field-programmable gate-arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. An energy control system comprising:
A hydrogen energy storage assembly including: an electrolyzer configured to separate, via electrolysis, water into hydrogen gas; a hydrogen storage system for storing the hydrogen gas produced by the electrolyzer; a hydrogen fuel cell configured to convert the stored hydrogen gas into electrical energy and water; an electrochemical energy storage module configured to function as an energy buffer; an inverter configured to convert the produced electrical energy to a desired form; a network interface; and a system controller communicatively coupled to a server system and a virtual power plant (VPP) service;
a solar power system communicatively coupled to the system controller and a consumer premises;
wherein the system controller is configured to:
receive data including: (a) a state of charge of the hydrogen storage system; (b) a state of charge of the electrochemical energy storage module; (c) a grid status; (d) a solar production value from the solar power system; and (e) home load data;
determine whether the consumer premises is on-grid based on the grid status;
determine whether there is surplus solar power based on the home load data and the solar production value;
activate a selected one of a set of specialized machine learning agents based on whether the customer premises is on-grid and whether there is surplus solar power; and
perform, within a set of guard rails, a suggested action provided by the selected specialized machine learning agent, wherein the suggested action is selected from the group consisting of: start generating hydrogen; stop generating hydrogen; start consuming hydrogen; stop consuming hydrogen; manage consumer premises loads; shed loads; and respond to the VPP service.

2. The energy control system of claim 1, wherein the set of guard rails include minimum and maximum values for the hydrogen energy storage assembly and the consumer premises loads.

3. The energy control system of claim 1, wherein the specialized machine learning agents include an on-grid surplus agent, an on-grid deficit agent, an off-grid surplus agent, and an off-grid deficit agent.

4. The energy control system of claim 1, wherein the data is stored in a plurality of databases by respective logger services at a set of predetermined intervals.

5. The energy control system of claim 1, wherein each of the specialized machine learning agents are implemented using a proximal policy optimization (PPO) model trained on past behavior of the energy control system.

6. The energy control system of claim 1, wherein the consumer premises includes a smart breaker system, and the home load data includes data from the smart breaker system.
